(19) United States
(12) Patent Application Publication
(10) Pub. No.: US 2017/0060600 A1
(43) Pub. Date: Mar. 2, 2017

(54) SYSTEMS AND METHODS FOR NAVIGATING WITHIN AND BETWEEN WEBSITES

(71) Applicant: MasterCard International Incorporated, Purchase, NY (US)

(72) Inventors: Bryan Niehaus, Clayton, MO (US); Corey Hively, Lake St. Louis, MO (US); Jennifer Rosa, Moscow Mills, MO (US); Suman Rausaria, Ballwin, MO (US); Tricia Nance, Wentzville, MO (US); Karen Randell, O'Fallon, MO (US); Matthew Thomas Holton, Wentzville, MO (US); Christopher Mullen, St. Peters, MO (US)

(21) Appl. No.: 14/836,539

(22) Filed: Aug. 26, 2015

(51) Int. Cl. G06F 9/44; G06F 3/0481; G06F 3/0482; G06F 3/0483

(52) U.S. Cl. CPC G06F 9/4446; G06F 3/0483; G06F 3/04817; G06F 3/0482

(57) ABSTRACT

A visitor guidance computing device for navigating a user between digital assets is provided. The visitor guidance computing device includes a processor and a memory. The processor is programmed to receive a request message to view a digital asset, wherein the request includes device data from a requesting user computing device, and to filter digital asset analytics using the device data to determine topics and sub-topics responsive to the device data. The processor is further programmed to store a hierarchical shell in the memory, the hierarchical shell having multiple layers of nodes, each node configured to store data relating to the topics and sub-topics, and to populate the layers with content for display as a guidance tool. The processor is also programmed to provide a widget that causes the guidance tool to be displayed, and to cause the widget and hierarchical shell to be provided with the requested digital asset.

### BACKGROUND OF THE DISCLOSURE

This disclosure relates generally to navigating within and between electronic websites, and more specifically to network-based systems and methods that include a hierarchical shell and a navigation widget causing display of a guidance tool for enabling users to more easily navigate within and between websites.

At least some known vendors own and/or maintain digital assets including, among other things, websites and computer apps that are sponsored by and display data relating to the vendor. The websites may include multiple webpages and may be owned and maintained by the vendor, or may be third-party websites that host vendor-owned or vendor-related content (e.g., YouTube®). These digital assets may enable users to query for information within the vendor website or apps. For example, a user may submit a query on a website about a particular service or a cost of such services provided by the vendor. If the information desired by the user can be located within the webpages included in the website, the website may display the information to the user. In some implementations, the information may be included in a list of results (e.g., search results).

At least some of these vendor digital assets, when unable to find the user-desired information, may offer the user alternative results. For example, a vendor website may display a search result page that includes “top picks” of other users, recommendations, and/or information that other users have viewed and/or found useful or relevant.

Unfortunately, in at least some cases, the vendor's digital assets may not interact with each other. The user may be accessing one website of the vendor while the desired information is on a different website. Since the digital assets are not in communication with each other, the user's query of one digital asset will not provide desired results to the user. The user may have to enter the same or a similar search query on each of the different websites or apps until the user finds the desired result. Searching each individual digital asset over time is cumbersome and labor intensive.

### BRIEF DESCRIPTION OF THE DISCLOSURE

In one aspect, a visitor guidance computing device for enabling a user to navigate between digital assets is provided. The visitor guidance computing device includes a processor in communication with a memory. The processor is programmed to receive a request message, generated at a user computing device, to view a digital asset associated with a vendor. The digital asset is a first webpage on a first website, and the request includes device data from the user computing device. The processor is also programmed to filter digital asset analytics using the received device data to determine a plurality of topics and a plurality of sub-topics responsive to the device data. Digital asset analytics include an analysis of vendor and non-vendor digital assets, and each of the plurality of sub-topics is associated with one of the plurality of topics. The processor is further programmed to store a hierarchical shell in the memory, the hierarchical shell having multiple layers of a plurality of nodes, with each of the nodes configured to store data relating to the plurality of topics and the plurality of sub-topics. The processor is still further programmed to populate the layers of the hierarchical shell with content for display on the user computing device as a guidance tool. The guidance tool includes a first tier having a navigation icon, a second tier of interactive icons including the plurality of topics, and a third tier of interactive icons including the plurality of sub-topics. The processor is also programmed to provide a widget that, when executed on the user computing device, causes the guidance tool to be displayed on the user computing device, and cause the widget and hierarchical shell to be provided to the user computing device with the requested digital asset.

In another aspect, a method for enabling a user to navigate between digital assets is provided. The method is implemented using a visitor guidance computing device including a processor in communication with a memory. The method includes receiving, by the visitor guidance computing device, a request message, generated at a user computing device, to view a digital asset associated with a vendor. The digital asset is a first webpage on a first website, and the request includes device data from the user computing device. The method also includes filtering digital asset analytics using the received device data to determine a plurality of topics and a plurality of sub-topics responsive to the device data. Digital asset analytics include an analysis of vendor and non-vendor digital assets, and each of the plurality of sub-topics is associated with one of the plurality of topics. The method further includes storing a hierarchical shell in the memory. The hierarchical shell has multiple layers of a plurality of nodes, with each of the nodes configured to store data relating to the plurality of topics and the plurality of sub-topics. The method still further includes populating the layers of the hierarchical shell with content for display on the user computing device as a guidance tool. The guidance tool includes a first tier having a navigation icon, a second tier of interactive icons including the plurality of topics, and a third tier of interactive icons including the plurality of sub-topics. The method also includes providing a widget that, when executed on the user computing device, causes the guidance tool to be displayed on the user computing device, and causing the widget and hierarchical shell to be provided to the user computing device with the requested digital asset.

In yet another aspect, a computer-readable storage medium having computer-executable instructions embodied thereon, wherein when executed by at least one processor, coupled to a memory, the computer-executable instructions cause the processor to: receive a request message, generated at a user computing device, to view a digital asset associated with a vendor. The digital asset is a first webpage on a first website, and the request includes device data from the user computing device. The computer-executable instructions also cause the processor to filter digital asset analytics using the received device data to determine a plurality of topics and a plurality of sub-topics responsive to the device data. Digital asset analytics include an analysis of vendor and non-vendor digital assets, and each of the plurality of sub-topics is associated with one of the plurality of topics. The computer-executable instructions further cause the processor to store a hierarchical shell in the memory. The hierarchical shell has multiple layers of a plurality of nodes, with each of the nodes configured to store data relating to the plurality of topics and the plurality of sub-topics. The computer-executable instructions still further cause the processor to populate the layers of the hierarchical shell with content for display on the user computing device as a guidance tool. The guidance tool includes a first tier having a navigation icon, a second tier of interactive icons including the plurality of topics, and a third tier of interactive icons including the plurality of sub-topics. The computer-executable instructions also cause the processor to provide a widget that, when executed on the user computing device, causes the guidance tool to be displayed on the user computing device, and cause the widget and hierarchical shell to be provided to the user computing device with the requested digital asset.

In a further aspect, a user computing device including a processor in communication with a memory and a user interface is provided. The user computing device is configured to receive a widget embedded on a first digital asset, and display, upon execution of the widget, a guidance tool on the user interface. The guidance tool includes a plurality of tiers of interactive icons, and wherein a first tier of the plurality of tiers includes a navigation icon. The user computing device is also configured to receive a first user selection of the navigation icon, and display, in response to the first user selection, a second tier of interactive icons. The second tier of interactive icons includes a plurality of topics. The user computing device is further configured to receive a second user selection of a second interactive icon from the second tier of interactive icons, the second interactive icon including a first topic of the plurality of topics, and display, in response to the second user selection, a third tier of interactive icons, the third tier of interactive icons including a plurality of sub-topics. Each sub-topic corresponds to one of the plurality of topics. The user computing device is also configured to receive a third user selection of a third interactive icon from the third tier of interactive icons, the third interactive icon including a first subtopic of the plurality of sub-topics and a link, and navigate, using the link, a user of the user computing device to a second digital asset containing information associated with first subtopic.

### BRIEF DESCRIPTION OF THE DRAWINGS

FIGS. 1-8 show example embodiments of the methods and systems described herein.

FIG. 1 is a simplified block diagram of an example Digital Asset Navigation system (DAN) including a visitor guidance computing device.

FIG. 2 is a simplified block diagram of an example digital asset that may be navigated.

FIG. 3 is a simplified block diagram of an example DAN requesting storage data.

FIG. 4 depicts an example hierarchical shell that may be maintained by the visitor guidance computing device shown in FIG. 1.

FIG. 5 is a diagram depicting a guidance tool that is executed by a widget on user computing device shown in FIG. 1.

FIG. 6 is a first diagram depicting the guidance tool shown in FIG. 6 being displayed on the user computing device shown in FIG. 1 in response to user interaction.

FIG. 7 is a second diagram depicting the guidance tool shown in FIG. 6 being displayed on the user computing device shown in FIG. 1 in response to user interaction

FIG. 8 is a flowchart of an example method implemented by the DAN system shown in FIG. 1 for navigating the user within and between websites.

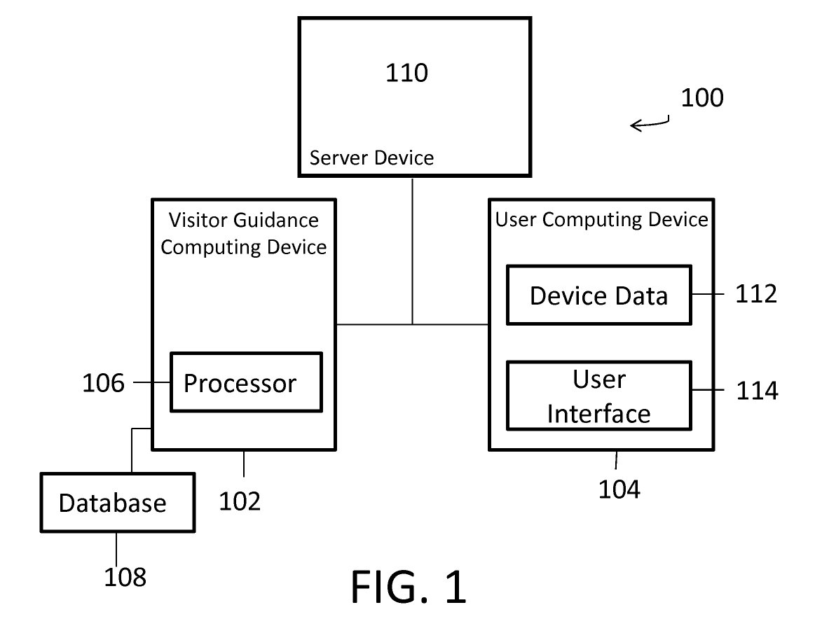

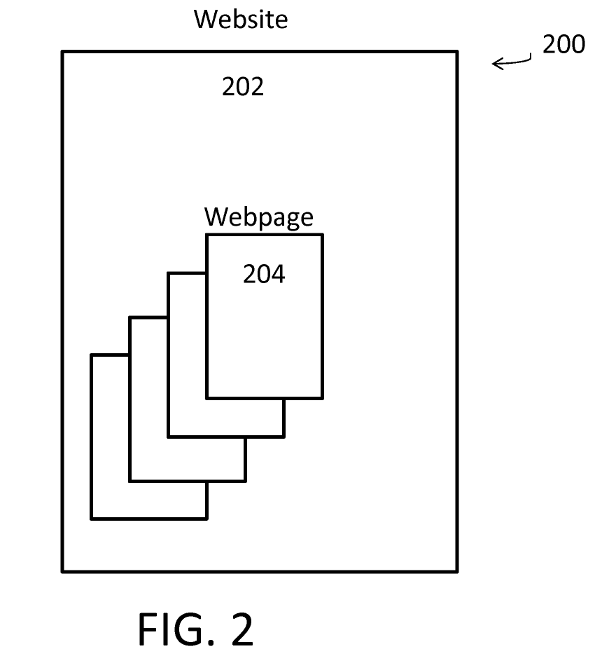

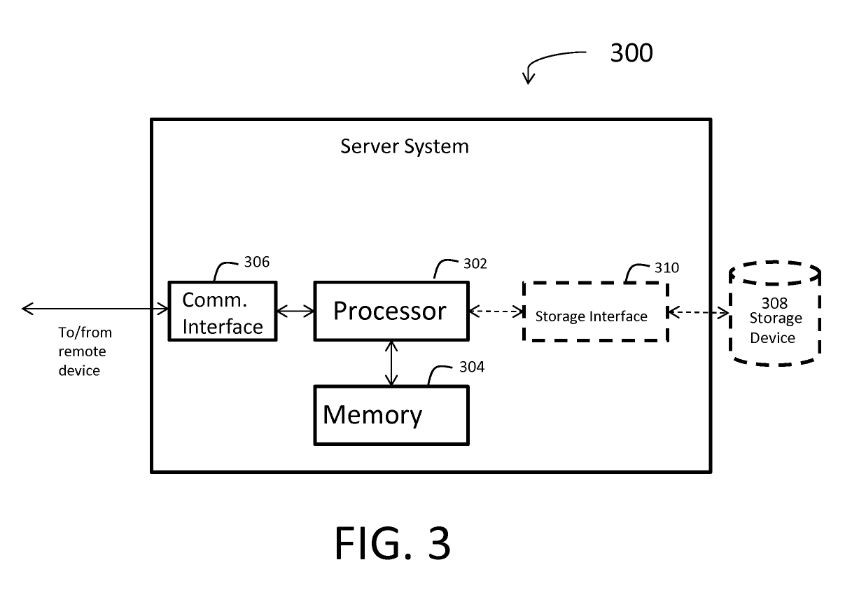

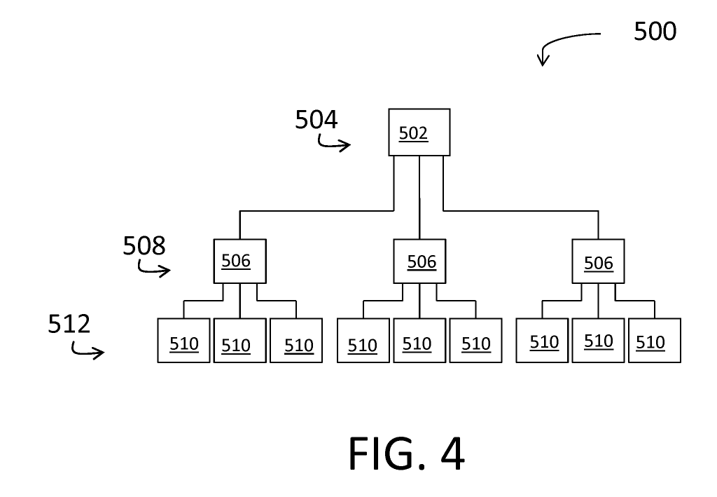

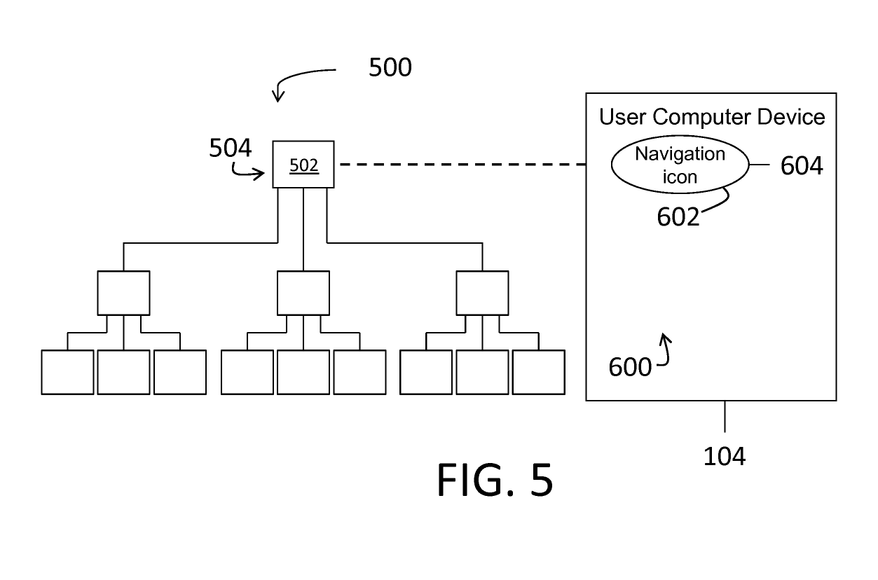

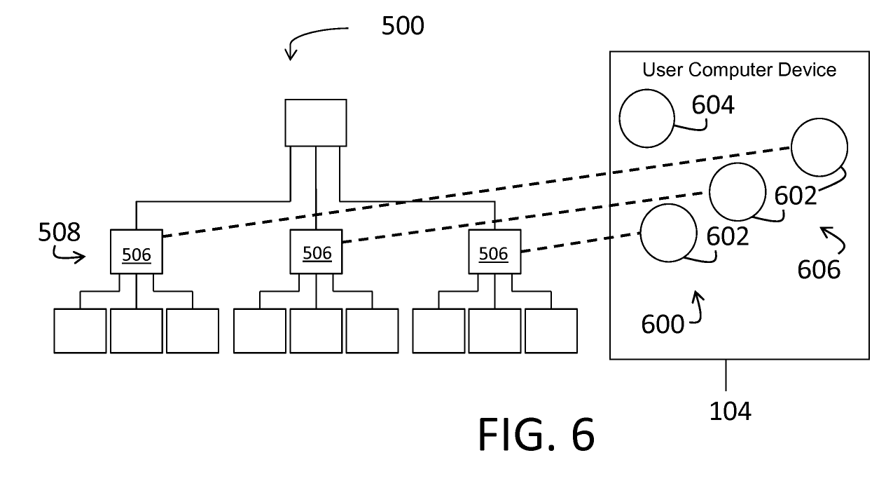

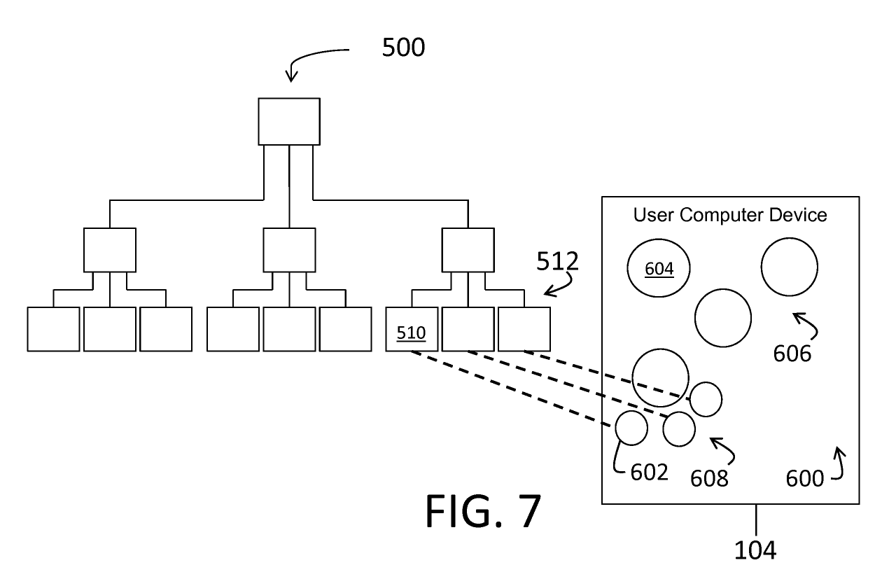

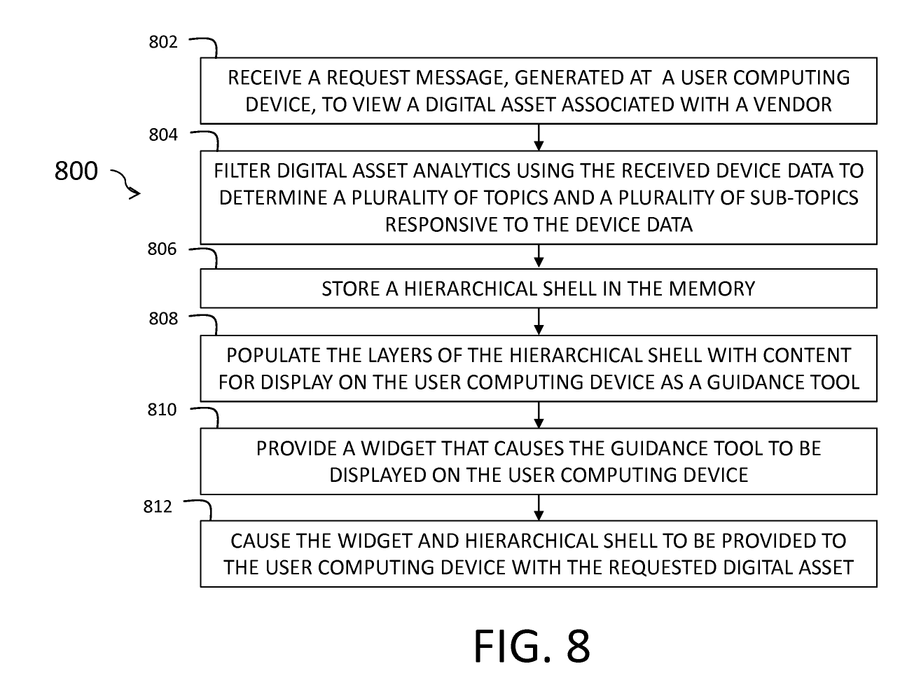

### DETAILED DESCRIPTION OF THE DISCLOSURE

The systems and methods described herein relate to navigating within and between websites, and more specifically to a system that includes a hierarchical shell and a navigation widget causing display of a guidance tool, which enables users to more easily navigate within and between websites. The system described herein is referred to as a Digital Asset Navigation (DAN) computing system. The DAN computing system includes a server device, a visitor guidance computing device having a memory and processor, and at least one user computing device, which may all be in communication with one another. The server device gathers data and provides access to digital assets that are accessed by users using one of the user computing devices. The data gathered may be provided to the visitor guidance computing device. The visitor guidance computing device uses the data received from the server device to populate the hierarchical shell. The populated hierarchical shell (with the populated data) and the widget are provided to the user computing device to a display guidance tool, including a navigation icon, on the user computing device. The user computing device displays the navigational icon to the user.

The server device gathers data and provides access to webpages, websites, and other digital assets. The server device gathers data from the user computing device and the visitor guidance computing device, as well as from user interaction with the digital assets outside of the DAN system (e.g., social media interaction, search queries, news outlets, etc.). When accessed by the user computing device, the server device provides certain digital assets to

What is claimed is:

1. A visitor guidance computing device for enabling a user to navigate between digital assets, said visitor guidance computing device including a processor in communication with a memory, wherein said processor is programmed to:
receive a request message, generated at a user computing device, to view a digital asset associated with a vendor, wherein the digital asset is a first webpage on a first website, and wherein the request includes device data from the user computing device;
filter digital asset analytics using the received device data to determine a plurality of topics and a plurality of sub-topics responsive to the device data, wherein digital asset analytics include an analysis of vendor and non-vendor digital assets, and wherein each of the plurality of sub-topics is associated with one of the plurality of topics;
store a hierarchical shell in the memory, the hierarchical shell having multiple layers of a plurality of nodes, with each of the nodes configured to store data relating to the plurality of topics and the plurality of sub-topics;
populate the layers of the hierarchical shell with content for display on the user computing device as a guidance tool, the guidance tool including a first tier having a navigation icon, a second tier of interactive icons including the plurality of topics, and a third tier of interactive icons including the plurality of sub-topics;
provide a widget that, when executed on the user computing device, causes the guidance tool to be displayed on the user computing device; and
cause the widget and hierarchical shell to be provided to the user computing device with the requested digital asset.

2. The visitor guidance computing device of claim 1, wherein said processor is further programmed to retrieve the digital asset analytics from a database maintained by the vendor, wherein the digital asset analytics include social sentiment data, historical data, recent search results for a plurality of users on the vendor and non-vendor digital assets, and marketing boosts.

3. The visitor guidance computing device of claim 2, wherein the processor is further programmed to apply a scoring algorithm to the plurality of topics, wherein the scoring algorithm is configured to weight at least one of the social sentiment data, the historical data, the recent search results and the marketing boosts.

4. The visitor guidance computing device of claim 1, wherein device data includes at least one of user location, device type, device brand, and user cookie data.

5. The visitor guidance computing device of claim 1, wherein a first user interaction with the navigation icon causes display of the second tier of interactive icons, and a second user interaction with a first icon of the second tier causes display of the third tier of interactive icons.

6. The visitor guidance computing device of claim 1, wherein a first layer of the hierarchical shell includes a primary node, wherein the hierarchical shell further includes at least a first branch that extends from the primary node to at least one secondary node in a second layer, and wherein at least a second branch extends from the at least one secondary node to a tertiary node.

7. The visitor guidance computing device of claim 1, wherein the digital asset is a first digital asset and wherein the populated hierarchical shell further includes at least one of the plurality of nodes that stores a user interactive link to navigate a user of the user computing device to a second digital asset.

8. A method for enabling a user to navigate between digital assets, said method implemented using a visitor guidance computing device including a processor in communication with a memory, said method comprising:
receiving, by the visitor guidance computing device, a request message, generated at a user computing device, to view a digital asset associated with a vendor, wherein the digital asset is a first webpage on a first website, and wherein the request includes device data from the user computing device;
filtering digital asset analytics using the received device data to determine a plurality of topics and a plurality of sub-topics responsive to the device data, wherein digital asset analytics include an analysis of vendor and non-vendor digital assets, and wherein each of the plurality of sub-topics is associated with one of the plurality of topics;
storing a hierarchical shell in the memory, the hierarchical shell having multiple layers of a plurality of nodes, with each of the nodes configured to store data relating to the plurality of topics and the plurality of sub-topics;
populating the layers of the hierarchical shell with content for display on the user computing device as a guidance tool, the guidance tool including a first tier having a navigation icon, a second tier of interactive icons including the plurality of topics, and a third tier of interactive icons including the plurality of sub-topics;
providing a widget that, when executed on the user computing device, causes the guidance tool to be displayed on the user computing device; and
causing the widget and hierarchical shell to be provided to the user computing device with the requested digital asset.

9. The method of claim 8, further comprising retrieving the digital asset analytics from a database maintained by the vendor, wherein the digital asset analytics include at least one of social sentiment data, historical data, recent search results for a plurality of users on the vendor and non-vendor digital assets, and marketing boosts.

10. The method of claim 9, wherein filtering digital asset analytics using the received device data further comprises applying a scoring algorithm to the plurality of topics, wherein the scoring algorithm is configured to weight at least one of the social sentiment data, the historical data, the recent search results and the marketing boosts.

11. The method of claim 8, further comprising processing the device data, wherein device data includes at least one of user location, device type, device brand, and user cookie data.

12. The method of claim 8, wherein a first user interaction with the navigation icon causes display of the second tier of interactive icons, and a second user interaction with a first icon of the second tier causes display of the third tier of interactive icons.

13. The method of claim 8, wherein a first layer of the hierarchical shell includes a primary node, wherein the hierarchical shell further includes at least a first branch that extends from the primary node to at least one secondary node in a second layer, and wherein at least a second branch extends from the at least one secondary node to a tertiary node.

14. The method of claim 8, wherein the digital asset is a first digital asset and wherein the populated hierarchical shell further includes at least one of the plurality of nodes that stores a user interactive link to navigate a user of the user computing device to a second digital asset.

15. A computer-readable storage medium for enabling a user to navigate within a digital asset, said computer-readable storage medium having computer-executable instructions embodied thereon, wherein when executed by at least one processor, coupled to a memory, the computer-executable instructions cause the processor to:
receive a request message, generated at a user computing device, to view a digital asset associated with a vendor, wherein the digital asset is a first webpage on a first website, and wherein the request includes device data from the user computing device;
filter digital asset analytics using the received device data to determine a plurality of topics and a plurality of sub-topics responsive to the device data, wherein digital asset analytics include an analysis of vendor and non-vendor digital assets, and wherein each of the plurality of sub-topics is associated with one of the plurality of topics;
store a hierarchical shell in the memory, the hierarchical shell having multiple layers of a plurality of nodes, with each of the nodes configured to store data relating to the plurality of topics and the plurality of sub-topics;
populate the layers of the hierarchical shell with content for display on the user computing device as a guidance tool, the guidance tool including a first tier having a navigation icon, a second tier of interactive icons including the plurality of topics, and a third tier of interactive icons including the plurality of sub-topics;
provide a widget that, when executed on the user computing device, causes the guidance tool to be displayed on the user computing device; and
cause the widget and hierarchical shell to be provided to the user computing device with the requested digital asset.

16. The computer-readable medium of claim 15, wherein the computer-executable instructions further cause the processor to retrieve the digital asset analytics from a database maintained by the vendor, wherein the digital asset analytics include social sentiment data, historical data, recent search results for a plurality of users on the vendor and non-vendor digital assets, and marketing boosts.

17. The computer-readable medium of claim 16, wherein the computer-executable instructions further cause the processor to apply a scoring algorithm to the plurality of topics, wherein the scoring algorithm is configured to weight at least one of the social sentiment data, the historical data, the recent search results and the marketing boosts.

18. The computer-readable medium of claim 15, wherein device data includes at least one of user location, device type, device brand, and user cookie data.

19. The computer-readable medium of claim 15, wherein a first user interaction with the navigation icon causes display of the second tier of interactive icons, and a second user interaction with a first icon of the second tier causes display of the third tier of interactive icons.

20. The computer-readable medium of claim 15, wherein a first layer of the hierarchical shell includes a primary node, wherein the hierarchical shell further includes at least a first branch that extends from the primary node to at least one secondary node in a second layer, and wherein at least a second branch extends from the at least one secondary node to a tertiary node.

21. The computer-readable medium of claim 15, wherein the digital asset is a first digital asset and wherein the populated hierarchical shell further includes at least one of the plurality of nodes that stores a user interactive link to navigate a user of the user computing device to a second digital asset.

22. A user computing device including a processor in communication with a memory and a user interface, said user computing device configured to:
receive a widget embedded on a first digital asset;
display, upon execution of the widget, a guidance tool on the user interface, wherein the guidance tool includes a plurality of tiers of interactive icons, and wherein a first tier of the plurality of tiers includes a navigation icon;
receive a first user selection of the navigation icon;
display, in response to the first user selection, a second tier of interactive icons, the second tier of interactive icons including a plurality of topics;
receive a second user selection of a second interactive icon from the second tier of interactive icons, the second interactive icon including a first topic of the plurality of topics;
display, in response to the second user selection, a third tier of interactive icons, the third tier of interactive icons including a plurality of sub-topics, each sub-topic corresponding to one of the plurality of topics;
receive a third user selection of a third interactive icon from the third tier of interactive icons, the third interactive icon including a first subtopic of the plurality of sub-topics and a link; and
navigate, using the link, a user of the user computing device to a second digital asset containing information associated with first subtopic.

23. A user computing device of claim 22 further configured to overlay the guidance tool on first digital asset, wherein the plurality of tiers of the guidance tool do not obstruct content of the first digital asset.
